(19) United States
(12) Patent Application Publication
(10) Pub. No.: US 2023/0144786 A1
(43) Pub. Date: May 11, 2023

(54) NOVEL FILTER MATERIAL, FACE MASK COMPRISING THE SAME AND METHOD OF MAKING THE SAME

(71) Applicant: KING'S FLAIR INNOVATIVE MARKETING LIMITED, Hong Kong (HK)

(72) Inventor: Siu Wah WONG, Hong Kong (CN)

(21) Appl. No.: 17/916,628

(22) PCT Filed: Apr. 2, 2021
(86) PCT No.: PCT/CN2021/085324

§ 371 Date: Oct. 3, 2022

Related U.S. Application Data
(60) Provisional application No. 63/004,764, filed on Apr. 3, 2020.

(51) Int. Cl. A62B 23/02; A41D 13/11; B01D 39/16; B01D 39/18

(52) U.S. Cl. CPC A62B 23/025; A41D 13/1192; B01D 39/1623; B01D 39/18; B01D 2239/025; B01D 2239/0636; B01D 2239/1291; B01D 2239/0442; B01D 2239/0421; B01D 2239/0428; B01D 2239/10; B01D 2239/0631; B01D 2239/083

(57) ABSTRACT

The present invention provides a filter material comprising an antistatic substrate having a predefined antistatic capacity, and one or more layers of nanofibers applied on the substrate. The one or more layers of nanofibers may be fabricated to have gradient structure in various parameters including thickness of nanofiber layer, nanofiber pore size, nanofiber diameter, nanofiber content and the like to suit different filtration applications. The present invention also provides a face mask comprising the filter material and a method for making the filter material.

### CROSS-REFERENCE TO RELATED APPLICATION

This application claims benefit of U.S. Provisional Application having Ser. No. 63/004,764 filed on Apr. 3, 2020, which is hereby incorporated by reference herein in its entirety.

### TECHNICAL FIELD OF THE INVENTION

The present invention relates to a novel filter material with porous structure comprising nanofibers as a filter element, to application of the filter material in face masks, and a method of making the filter material. The filter material may have a gradient material in various parameters including material thickness, fiber pore size, fiber diameter, fiber content and the like.

### BACKGROUND OF THE INVENTION

The importance of materials with porous structure made from fibers in the nanoscale and/or submicron scale increases rapidly due to the properties of highly porous structure, narrow pore size, and distribution and specific surface area, which leads to a variety of applications in face masks, air filtrations, water purification, liquid filtration, desalination, distillation, tissue engineering, protective clothing, composites, battery separators, sensors, wound dressing, etc.

Face masks find a wide range of applications as a means to catch the bacteria shed in liquid droplets and aerosols from the wearers' mouths and noses. The outbreak and spread of coronavirus have caused a shortage of face masks, including surgical face masks for consumer purchase and N95 face masks for medical personnel. Both types of face masks require a once-obscure material called melt-blown fabric. The melt-blown fabric is an extremely fine mesh of synthetic polymer fibers that forms the critical inner filtration layer of a mask, allowing the wearer to breath while reducing the inflow of possible infectious particles. There is now a global shortage of melt-blown fabric due to the increased demand for masks and the difficulty in producing this material.

Electrospinning is one of the techniques to generate high quality ultra-thin fibers with a diameter ranging from a few tens of nanometres to a few tens of micrometres for the fabrication of polymeric materials with porous structure. Nanofibers produced from electrospinning have enormous properties such as high surfaced area, highly pore structure, small pore size and so on, and therefore can be used for filtration. Nanofibers can tremendously improve the performance of filter media's ability to remove particulates from air streams. Nanofibers could be the key elements for filter materials in face masks or other air filtration applications, and their very high surface area per unit mass enhances capture efficiency.

Accordingly, it is desirable to have a nanofiber filter media in place of melt blown fabrics, for example polypropylene melt blown (PPMB) fabric which is widely used in making face masks in the art, in order to replace melt blown fabric or at least fill the deficit of melt blown fabric.

### SUMMARY OF THE INVENTION

The present invention has been developed to fulfill the needs noted above and therefore has a principle object of provision of a filter material comprising fibers in the nanoscale and/or submicron scale as a filter element.

Another object of the invention is to provide a filter material which may be used as an alternative of PPMB and which exhibit comparable with or even better filtration performance than PPMB.

A yet object of the invention is to provide a filter material comprising functionalized nanofibers and/or submicron fibers with antibacterial and biocidal functions.

The above and other objects can be achieved by provision of a filter material comprising:
an antistatic substrate having a predefined antistatic capacity, and one or more layers of nanofibers applied on the substrate.

The substrate preferably has a high antistatic performance to facilitate deposition of nanofibers thereon, and may include any porous and non-woven materials that may provide mechanical strength to support the one or more layers of nanofibers. It may comprise one or more polymer-based fibers selected from polypropylene, polyester, nylon, polyethylene, polyurethane, cellulose, polybutylene terephthalate, polycarbonate, polymethylpentene and/or polystyrene, and feasible polymers known in the art, which are present at different concentrations and have different molecular weights.

In one preferred embodiment of the invention, the nonwoven fabric is spunbonded polypropylene (PPSB) or polyethylene terephthalate (PET). Generally, PPSB or PET has an electric resistance which is at least 10⁶ Ω, for example in the range of 10⁶ to 10¹¹ Ω, preferably in the range of 10⁷ to 10¹⁰ Ω, to produce small and fine fiber diameters and form fibers with beads on the substrate in order for increased breathability. The beads may be generated by adding nanoparticles into the polymer solution for electrospinning the nanofibers.

The nanofibers useful in the invention may be selected from a group consisting of hydrophilic polymers and hydrophobic polymers. Particularly, the nanofiber may be selected from a group consisting of polyolefin, polyamide, polyester, cellulose ether and ester, cellulose acetate, polyvinylidene fluoride, polyacrylonitrile, polyvinyl alcohol, polyethersulfone, nylon, polystyrene, polycarbonate, chitosan, or any mixture thereof.

The nanofibers may comprise an interlaced structure which includes interlacing of nanofibers of different types, interlacing of nanofibers of different diameters, interlacing of nanofibers of different polymer identity, interlacing of nanofibers of different pore sizes, interlacing of nanofibers with microfibers. The interlaced structure may have a gradient in fiber density, fiber pore size, fiber diameter, fiber content and material thickness.

According to the invention, the one or more layers of nanofibers can intercept particles in the nanometer size range or sub-micron size range. The nanofiber layers of filter material may vary in thickness, diameter, mean pore size and maximum pore size.

In some cases, the filter material may comprise one or more layers on both sides of the substrate.

Preferably, the one or more layers of nanofibers are functionalized to have antimicrobial, antiviral and/or antibacterial properties, or are crossed linked to a layer of biocides to have antimicrobial, antiviral and/or antibacterial properties.

A second aspect of the present invention provides a face mask comprising
an outer protective layer exposed to an external environment,
an inner layer configured to fit for covering the mouth and nose of a wearer,
at least one intermediate filter layer comprising the filter material of the invention and sandwiched between the outer layer and the inner layer, and
means for securing the face mask to the wearer's face.

The intermediate filter layer is hydrophobic and the inner layer is hydrophilic such that moisture is absorbed by the inner layer as possible while the intermediate layer has the least moisture when the face mask is worn.

In one specific embodiment of the invention, one or more of the outer layer, the intermediate filter layer, and the inner layer comprise an antimicrobial agent and/or a moisture absorbing agent.

A third aspect of the invention provides a method of making a filter material of the invention, comprising the steps of:
a) electrospinning a first polymer solution onto a substrate from a first group of spinning electrodes to deposit first nanofibers on the substrate,
b) electrospinning a second polymer solution onto the substrate from a second group of spinning electrodes to deposit second nanofibers on the first nanofibers, wherein the second polymer solution and the first polymer solutions are same or different, and
c) drying the polymer-based material electrospun from the first polymer solution and the second polymer solution.

It is preferred to apply adhesive to the substrate prior to step a). In step b), the first polymer solution and the second polymer solutions may be same or different in terms of solution parameters, including but not limited to type of polymer, solution concentration of polymer.

The first group of spinning electrodes and the second group of spinning electrodes are spaced apart in a manner that a transition layer comprising the first nanofibers and the second nanofibers is created.

In a particularly preferred embodiment of the invention, the method is performed for continuous needleless electrospinning of the one or more nanofiber layers on the substrate. The method may comprise the step of varying at least one of parameters selected from the group consisting of: viscosity, surface tension and antistatic performance of the polymer solutions, a travelling speed of the substrate, a voltage applied between the spinning electrodes and a collection electrode, a distance between the spinning electrodes and the collection electrode, and composition of the first and second polymer solutions.

The first or second polymer solution may be selected from a group consisting of polyolefin, polyamide, polyester, cellulose ether and ester, cellulose acetate, polyvinylidene fluoride, polyacrylonitrile, polyvinyl alcohol, polyethersulfone, nylon, polystyrene, polyacrylonitrile, polycarbonate, chitosan, or any mixture thereof.

The method of the invention may also comprise the step of adding into the first polymer solution and/or the second polymer solution nanoparticles to functionalize the nanofibers, and/or biocides to incorporate antimicrobial, antiviral and/or antibacterial properties into the nanofibers.

### BRIEF DESCRIPTION OF THE DRAWING

FIG. 1 is a schematic diagram of an exemplary needleless electrospinning system in which two polymer solutions are supplied to eight spinning electrodes for making a filter material according to the present invention.

FIG. 2 is a process flow diagram illustrating an exemplary method of making the filter material of the present invention.

### DETAILED DESCRIPTION OF THE INVENTION

The invention primarily relates to a filter material comprising nanofibers and/or submicron fibers in place of PPMB fabric which is widely used in making face masks in the art. The filter material exhibits increased filtration efficiency for removing nano-sized and/or sub-micron particles from the air flowing across the filter material.

One particular application of the filter material of the invention is found in face masks which protect the wearers from inhalation of airborne pollutants, impurities, bacterial and virus. Due to the presence of one of more layers of nanofibers in the filter material of the invention, increased filtration efficiency is obtainable for the face masks to remove nano-sized and/or sub-micron particles from the air flowing across the whole face mask. These nano-sized or sub-micron particles, including but not limited to, viruses, bacteria, dusts, or allergic materials. At the same time, there is non-significant increase in pressure drop.

It is the inventor's finding that the face masks comprising a filter layer made up of a layer of very low weight nanofibers of the invention and a layer of thin PPSB fabric are easy breathing and very comfortable in terms of use, and also fully meets the wearer's expectations with its flexible structure and morphology that easily passes moisture.

A face mask is well known to generally comprise an outer protective layer exposed to an external environment, an inner layer adapted to cover the mouth and nose of a wearer, and at least one intermediate filter layer comprising the filter material of the invention and sandwiched between the outer layer and the inner layer.

The outer layer and the inner layer may be selected from the ones known in the art, and are preferably made of nonwoven material comprising one or more polymers selected form a group consisting of polyolefin (polypropylene, polyethylene, etc.), polyester, polyamide, polycarbonate, polystyrene, or mixtures thereof. The outer layer is fluid repelling and enables to block larger particles. The inner layer is moisture absorbing, and more preferably made of soft and comfortable materials to the wearer and/or hypoallergenic materials.

Preferably, the outer layer and/or the inner layer are hydrophilic, and the intermediate filter layer is hydrophobic. Therefore moistures from the external environment and exhaled from the wearer are trapped in the outer and inner layers, whereas the intermediate filter layer is prevented from any moisture and has the least moisture to exert the proper filtering function when the face mask is worn.

According to the invention, a needleless electrospinning electrospinning method is utilized to make the filter layer of the invention, in which a high electric field is used to produce nanofibers on the basis of a high-voltage electric field applying between the spinning electrodes and the collection electrode. Particularly, the method comprises the steps of:
a) providing collection electrode above an antistatic substrate,
b) providing one or more spinning electrodes below the substrate,
c) supplying one or more polymer solutions to the one or more spinning electrodes,
d) applying a voltage between the collection electrode and the one or more spinning electrodes within active spinning zones,
e) applying an adhesive on the substrate before entering the active spinning zones and driving the substrate to pass through the active spinning zones between the collection electrode and the one or more spinning electrodes from upstream to downstream,
f) drawing the one or more polymer solutions into respective nanofibers from each of the spinning electrodes for deposition of the nanofibers onto the substrate within the active spinning zones to form one or more layers of nanofibers on the substrate, and
g) after the substrate with the nanofibers deposited leaves the active spinning zones, drying e.g. applying hot air to dry, at least one layers of nanofibers to afford the filter material.

The substrate may be a flat and planar sheet. The substrate may also be in the form of discrete sheets or continuous sheet, for example PPSB or PET having an electric resistance in the range of 10⁶ to 10¹¹ Ω, preferably in the range of 10⁷ to 10¹⁰ Ω.

The polymer solution comprises at least one polymer precursors and at least one solvent. In one embodiment of the invention, the polymer solution is used for forming polymeric fiber, which is selected from a group consisting of hydrophilic polymers and hydrophobic polymers. Particularly, the polymer solution is used for forming polymeric fibers selected from a group consisting of polyolefin, polyamide, polyester, cellulose ether and ester, cellulose acetate, polyvinylidene fluoride, polyacrylonitrile, polyvinyl alcohol, polyethersulfone, nylon, polystyrene, polyacrylonitrile, polycarbonate, chitosan, or mixtures thereof. Optionally, nanoparticles can be added to the polymer solution to functionalize the polymer fiber. In another embodiment, biocides can be added to the polymer solution to incorporate antimicrobial, antiviral and/or antibacterial properties into the polymer fiber.

The spinning electrode may comprise electric conducting string in the active spinning zone, and a carrying member is provided which is driven to be movable in reciprocating manner on the electric conducting string for continuous application of the polymer solution onto the electric conducting string. Preferably, the electric conducting string is substantially perpendicular to the direction of movement of the substrate. Accordingly, the nanofibers drawn from the polymer solution on the electric conducting string in the active spinning zones can be deposited on the substrate sequentially from the upstream spinning electrode to the downstream spinning electrode. The electric conducting string can be made of conducting metal or other conductive material. The electric conducting string is mounted substantially perpendicular to the direction of movement of the substrate. Preferably, the electric conducting strings are arranged parallel to each other. Particularly, the diameter of the nanofibers can be affected by the movement speed of the carrying member coupled on the electric conducting string.

One or more polymer solutions can be supplied respectively to one or more groups of spinning electrodes. The supplied polymer solutions may be of same polymer solution or different polymer solutions at same or different concentrations according to the actual needs.

Optionally, the resultant substrate deposited with nanofibers may be repeatedly entering the needleless electrospinning zones to allow for further deposition of the same fibers to increase the thickness of the nanofiber layer, or fibers of different diameters and/or different polymer identities to form two or more nanofiber layers.

In accordance with actual needs or requirements, at least one layer of nanofibers may be deposited on one side of the substrate, or on both sides of the substrate.

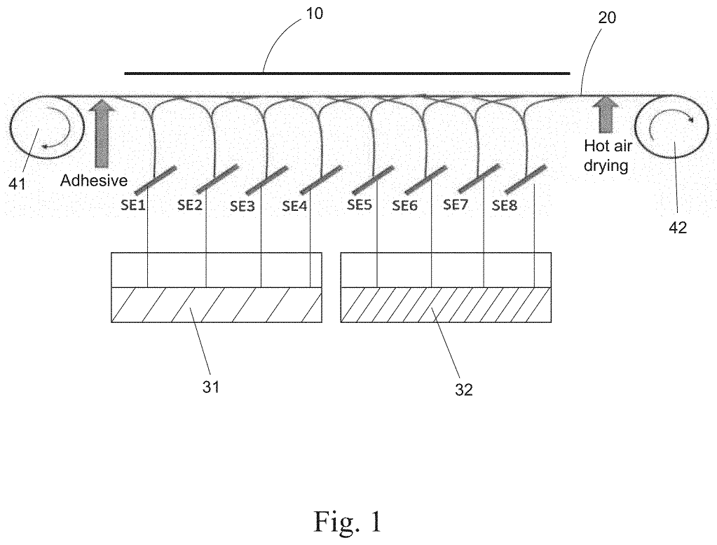

Referring now specifically to FIG. 1, there is illustrated a needleless electrospinning system for making a filter material according to one preferred embodiment of the present invention. In this illustrated system, there are a first group of four spinning electrodes SE1, SE2, SE3 and SE4 and a second group of our spinning electrodes SE5, SE6, SE7 and SE8 placed in parallel. The eight spinning electrodes are controlled to operate independently and have their respective polymer solution reservoirs for supplying the polymer solutions, therefore different polymer solutions may be loaded to the spinning electrodes to electrospin different types of nanofibers.

A collection electrode 10 is provided above these eight spinning electrodes SE1 to SE8. In this system, PPSB is used as a continuous substrate 20 travelling between the collection electrode 10 and the eight spinning electrodes SE1 to SE8. The substrate 20 is subject to deposition of nanofibers drawn from the spinning electrodes when it travels from an upstream take-up cylinder 41 to a downstream take-up cylinder 42.

The first group of spinning electrodes SE1 to SE4 is arranged at the upstream region defining a first active spinning zone, and the spinning electrodes SE1 to SE4 are supplied with a first polymer solution 31. The second group of spinning electrodes SE5 to SE8 are arranged at the downstream region defining a second active spinning zone, and the spinning electrodes SE5 to SE8 are supplied with a second polymer solution 32. The first and second polymer solutions 31, 32 may be of different types of polymer solution having same or different concentration, and the first and second polymer solutions 31, 32 are of the same type in this embodiment. Particularly, the first polymer solution 31 applied to the first group of spinning electrodes SE1 to SE 4 in the first active spinning zone produces first nanofibers having a first diameter, and the second polymer solution 32 applied to the second group of spinning electrodes SE5 to SE8 in the second active spinning zone produces second fibers having a second diameter smaller than the first diameter. When the first group of spinning electrodes and the second group of spinning electrodes are spaced apart in an appropriate distance, an intermediate active spinning zone may be arranged such that the first nanofibers and the second nanofibers are interlaced with each other to form a transition layer.

It would be appreciated that three or more nanofibers may be generated from three or more groups of spinning electrodes with a predefined number of polymer solutions, thereby more layers of nanofibers can be formed in the resulting filter material. Also, it would be within the ability of a person skilled in the art that eight different polymer solutions may be fed into the eight spinning electrodes SE1 to SE8 to generate eight different types of nanofibers and eight different diameters of nanofibers.

As mentioned above, PPSB is used as the antistatic substrate 20 and preferably has an electric resistance in the range of 10⁷ to 10¹⁰ Ω according to the invention. The PPSB web is loaded into the upstream take-up cylinder 41 and is applied with adhesive, for example, known in the art before it enters into the first active spinning zone. Suitable PPSB webs are commercially available and particularly those with a skin or surface layer having a lower softening point.

The PPSB web moves in the direction from the upstream take-up cylinder 41 to the downstream take-up cylinder 42, the first polymer solution 31 from the spinning electrodes SE1 to SE4 in the first active spinning zone is electrospun and drawn up into the first nanofibers for deposition on the PPSB web to form a first nanofiber layer. The PPSB web deposited with the first nanofiber layer continues to move to the second active spinning zone where the second polymer solution 32 from the spinning electrodes SE5 to SE8 in the second active spinning zone is electrospun and drawn up into the second nanofibers for deposition on the first nanofiber applied on the PPSB web, and forms a second nanofiber layer.

As shown in FIG. 1, a hot air system is arranged to follow the second active spinning zone and precede the downstream take-up cylinder 42 to dry the nanofibers deposited on the PPSB web to afford the filter material.

Preferably, a mounting arrangement (not shown) is arranged to guide the movement of the substrate, and a gas ventilation system (not shown) is provided to control the temperature, humidity and output of hot air within the needleless electrospinning zones.

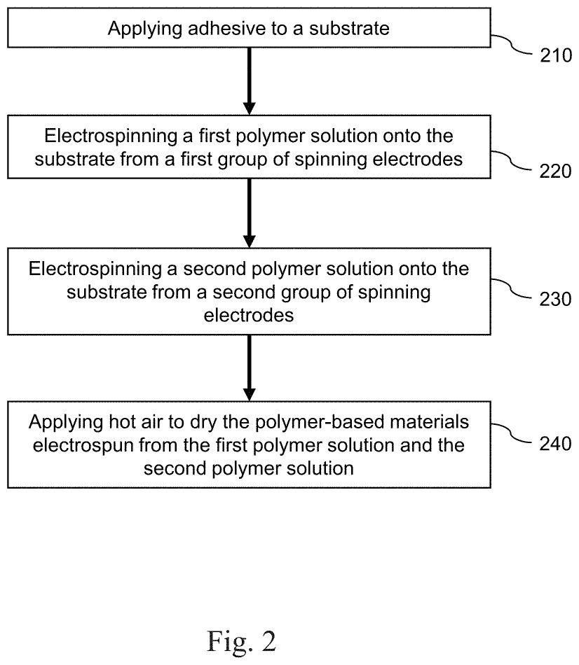

FIG. 2 illustrates a process flow diagram of the method in accordance with the invention. The process comprises applying adhesive to a substrate (step 210); electrospinning a first polymer solution for deposition of first nanofibers onto the substrate from a first group of spinning electrodes (step 220); electrospinning a second polymer solution onto the first nanofibers deposited the substrate from a second group of spinning electrodes (step 230); and applying hot air to dry the polymer-based material electrospun from the first polymer solution and the second polymer solution (step 240). In step 230, the second polymer solution and the first polymer solutions may be same or different in terms of solution parameters, including but not limited to type of polymer, solution concentration of polymer.

The needleless electrospinning method of the invention allows for variation in the parameters selected from the group consisting of a speed at which the PPSB web passes through the active spinning zones, a voltage applied between the spinning electrodes and the collection electrode, a distance between the electrodes, and the composition of the first and second polymer solutions. Such a variation may result in change of the structure of nanofibers, thickness of nanofiber layer, density of deposition, and diameter of the nanofibers. The two major features usually found in the nanofiber layers are a uniform, continuous fibrous structure and a bead-containing fibrous structure. Variation in the relative abundance of these two structures is determined by the relative contributions of the parameters during the electrospinning process.

Various polymer solutions and electrospinning parameters can be chosen to produce nanofibers of different polymers having different diameters. One example of the polymer solutions used in the invention is 4%, 8%, 12%, 16%, or 20% polyacrylonitrile (PAN) solution containing 0.2%, 0.4%, 0.6%, 0.8%, or 1% additive (for example biocide) for killing bacteria in a solvent, for example, dimethyl formamide (DMF). In one particular embodiment of the invention, the first and second polymer solutions comprise 4% and 8% of PAN respectively containing 0.4% biocide such as octenidine dihydrochloride (OCT), silver nanoparticles or other suitable biocides in DMF.

For the fabrication of the biocides, the first and second polymer solutions prepared for electrospinning the nanofibers may be blended with a biocide and a crosslinker so that biocide-crosslinked nanofibers can be electrospun. Alternatively, a crosslinker and a biocide may be deposited directly to bind to the nanofiber layers of the filter material.

The PPSB web travels from the upstream take-up cylinder 41 to the downstream take-up cylinder 42 at a speed in the range of 1 m/min to 60 m/min, preferably in the range of 3 m/min to 10 m/min. Adjustment of the distance between the spinning electrodes and the speed of the PPSB web allows for control of the thickness of the nanofibers deposited on the PPSB web. The thickness of the nanofiber layers can also be characterized by the amount of the first and second polymer solutions 31, 32 used for coating the surface area of the PPSB web. For example, the method of the present invention can manufacture the nanofibers using about 1 kg of the polymer solutions for deposition on a substrate having a surface area of about 1.6 m×500 m.

According to the method of the invention, it is easy and convenient to utilize two or more different polymer solutions to form different types of nanofiber layers. The term “different types” as defined herein may refer to same or different nanofibers that are produced using different compositions and/or concentrations of polymer solutions and/or that have different average diameters or different average diameter ranges. Similarly, the method utilizing the first and second polymer solutions as discussed above can be configured to create an intermediate active spinning zone between the adjacent spinning electrodes SE4 and SE5 respectively applying the first and second polymer solutions 31, 32 for formation of an intermediate layer which comprises an interlaced structure formed by the first nanofibers and the second nanofiber. The intermediate layer of nanofibers is sandwiched the first and second layers of nanofibers.

Therefore, a filter material is fabricated to comprise a first nanofiber layer with a first porous size, an intermediate layer of first nanofibers interlaced with second nanofibers, and a second nanofiber layer with a second porous size smaller than the first porous size when the PPSB web travels from the upstream take-up cylinder 41 to the downstream take-up cylinder 42. The filter material of such multilayered structure provides a porosity gradient, in particular has a gradual decrease in porous size in the direction of material thickness from the first layer to the second layer. This creates a filtration gradient across the multilayered nanofibers. The filtration gradient is particularly useful for a facemask.

Herein the “gradient” may refer to the material's properties, for example fiber density, fiber pore size, fiber diameter, fiber content, thickness of nanofiber layer, and the like.

In addition to this, every two adjacent spinning electrodes may be adjusted for their spacing (i.e. the distance between two adjacent spinning electrodes in the same active spinning zone), such that a corresponding intermediate active spinning zone is created to form an interlaced structure having gradual change in the fiber contents of the fibers in the direction of layer thickness. The interlaced structure includes interlacing of nanofibers of different types, interlacing of nanofibers of different diameters, interlacing of nanofibers of different pore sizes, interlacing of nanofibers with microfibers, interlacing of microfibers of different types, interlacing of microfibers of different diameters, interlacing of microfibers of different pore sizes.

The filter material made according to the needleless electrospinning method of the invention has been found to have well-distributed nanofibers with small mean diameter, and exhibit high filtration efficiency and low flow resistance of air filtration, which is a good alternative of air filtration material PPMB widely used in making face masks in the art. The face mask comprising the nanofiber filter material of the invention as the filter layer has a comparable with or even better filtration performance than PPMB.

One or more layers of the filter material comprising the nanofiber layers may be sandwiched between the outer and inner layers, for example by welding, e.g., heat welding or ultrasonic welding around the perimeters of the outer, inner and filter layers, in the normal manner to fabricate a face mask.

The means for securing the face mask to the wearer's face may be in the form of straps which are attached to the face mask in any conventional manner, e.g., welding or stapling elastic material or buckles.

The method according to the invention provides ease and convenience of making a filter material with desirable porous structure with a greater flexibility, reduced production time and operation costs. The filter material can well fill the deficit of PPMB to make filtration face masks and respirators.

Therefore, the invention provides a nanofiber filter material adapted for use in face masks which provide the necessary protection against viral risks and which are comfortable enough for daily use as well as medical application. The method for making the filter material according to the invention provides the flexibility and ease of individually varying the polymer solutions and electrospinning parameters for the multiple devices, thereby electrospin the nanofibers of different diameters which may be made from different polymers to fit for filter elements of face masks.

The above-described is preferred embodiments of the filter material of the present invention, the face masks comprising the filter material and the method for making the filter material. It is understood that the present invention is not limited to the above embodiments, and any appropriate alternatives, modifications, and variations apparent to those skilled in the art can be adopted within the scope of the present invention, as long as they can achieve the effects of the present invention.

1. A filter material, comprising:
an antistatic substrate having a predefined antistatic capacity, and one or more layers of nanofibers applied on the substrate.

2. The filter material according to claim 1, wherein the substrate comprises a nonwoven fabric comprising one or more polymer-based fibers selected from polypropylene, polyester, nylon, polyethylene, polyurethane, cellulose, polybutylene terephthalate, polycarbonate, polymethylpentene, polystyrene, spunbonded polypropylene (PPSB), and/or polyethylene terephthalate (PET).

3. The filter material according to claim 2, wherein the substrate has an electric resistance at least of 10⁶ Ω, preferably in the range of 10⁶ to 10¹¹ Q, and more preferably in the range of 10⁷ to 10¹⁰ Ω.

4. The filter material according to claim 1, wherein the nanofibers are selected from a group consisting of polyolefin, polyamide, polyester, cellulose ether and ester, cellulose acetate, polyvinylidene fluoride, polyacrylonitrile, polyvinyl alcohol, polyethersulfone, nylon, polystyrene, polycarbonate, chitosan, or any mixture thereof.

5. The filter material according to claim 1, wherein the nanofibers comprise an interlaced structure which includes interlacing of nanofibers of different types, interlacing of nanofibers of different diameters, interlacing of nanofibers of different polymer identity, interlacing of nanofibers of different pore sizes, and/or interlacing of nanofibers with microfibers.

6. The filter material according to claim 5, wherein the interlaced structure has a gradient in fiber density, fiber pore size, fiber diameter, fiber content and/or material thickness.

7. The filter material according to claim 1, wherein the one or more layers of nanofibers are deposited on both sides of the substrate, preferably deposited with beads on the substrate.

8. The filter material according to claim 1, wherein the one or more layers of nanofibers are functionalized to have antimicrobial, antiviral and/or antibacterial properties, or are cross linked to a layer of biocides.

9. A face mask comprising:
an outer protective layer exposed to an external environment,
an inner layer configured to fit for covering the mouth and nose of a wearer,
at least one intermediate filter layer sandwiched between the outer layer and the inner layer, the at least intermediate filter layer comprising a filter material which has an antistatic substrate having a predefined antistatic capacity, and one or more layers of nanofibers applied on the substrate, and
means for securing the face mask to the wearer's face.

10. The face mask according to claim 9, wherein the intermediate filter layer is hydrophobic and the inner layer is hydrophilic such that moisture is absorbed by the inner layer while the intermediate layer has the least moisture when the face mask is worn.

11. The face mask according to claim 9 or 10, wherein one or more of the outer layer, the intermediate filter layer, and the inner layer comprise an antimicrobial agent and/or a moisture absorbing agent.

12. A method of making a filter material comprising the steps of:
a) electrospinning a first polymer solution onto an antistatic substrate from a first group of spinning electrodes to deposit first nanofibers on the substrate,
b) electrospinning a second polymer solution onto the substrate from a second group of spinning electrodes to deposit second nanofibers on the first nanofibers, wherein the second polymer solution and the first polymer solutions are same or different, and
c) drying the polymer-based material electrospun from the first polymer solution and the second polymer solution.

13. The method according to claim 12, further comprising the step of applying adhesive to the substrate prior to step a).

14. The method according to claim 12, wherein in step b), the first polymer solution and the second polymer solutions are same or different in terms of solution parameters, including type of polymer, solution concentration of polymer.

15. The method according to claim 12, wherein the first group of spinning electrodes and the second group of spinning electrodes are spaced apart in a manner that a transition layer comprising the first nanofibers interlaced with the second nanofibers is created.

16. The method according to claim 12, wherein the method is performed for continuous needleless electrospinning of the one or more nanofiber layers on the substrate.

17. The method according to claim 16, further comprising the step of varying at least one of parameters selected from the group consisting of: viscosity, surface tension and antistatic performance of the polymer solution, a travelling speed of the substrate, a voltage applied between the spinning electrodes and a collection electrode, a distance between the spinning electrodes and the collection electrode, and composition of the first and second polymer solutions.

18. The method according to claim 12, wherein the first or second polymer solution is selected from a group consisting of polyolefin, polyamide, polyester, cellulose ether and ester, cellulose acetate, polyvinylidene fluoride, polyacrylonitrile, polyvinyl alcohol, polyethersulfone, nylon, polystyrene, polyacrylonitrile, polycarbonate, chitosan, or any mixture thereof.

19. The method according to claim 18, further comprising the step of adding into the first polymer solution and/or the second polymer solution nanoparticles to functionalize the nanofibers, and/or biocides to incorporate antimicrobial, antiviral and/or antibacterial properties into the nanofibers.
